(19) United States
(12) Patent Application Publication
(10) Pub. No.: US 2013/0147754 A1
(43) Pub. Date: Jun. 13, 2013

(54) PORTABLE TOUCH CONTROL ACCESSORY

(71) Applicant: Hsin-Hung Chuang, Jhongli City (TW)

(72) Inventor: Hsin-Hung Chuang, Jhongli City (TW)

(21) Appl. No.: 13/324,659

(22) Filed: Dec. 13, 2011

(51) Int. Cl. G06F 3/044

(52) U.S. Cl. 345/174; 178/18.06

(57) ABSTRACT

A portable touch control accessory comprises a connecting part, a touch control component, a connecting device and a conductive part: The connecting part is a nonconducting tubular component with a bore at one end which is adequately coupled with columnar paraphernalia; The touch control component is conductive and mounted on the connecting part's other end via a connecting device; The conductive part, conductive and flexible, is electrically connected to the touch control component and has at least one portion exposed. As an extra accessory which is installed on paraphernalia held by one user, the portable touch control accessory allows the touch control component to contact the human body via the conductive part for a ground loop developed and the paraphernalia used in operation of a capacitive touch panel.

### BACKGROUND OF THE INVENTION

(1) Field of the Invention

The present invention relates to a capacitive touch control accessory, especially a portable touch control accessory installed on columnar paraphernalia for the paraphernalia used in operating a capacitive touch panel.

(2) Description of the Prior Art

The prosperous electronic industry has accelerated 3C products available in the market wherein touch interfaces have become a trend and mainstream designed on 3C products. Basically, a touch interface is developed with integration of one graphic operation system (software) and one touch panel (hardware) which can be classified into a resistive touch panel, a capacitive touch panel, an optic touch panel, an electromagnetic touch panel or an ultrasonic touch panel according to its induction theory. The touch panels applied to personal digital assistants or mobile phones initially are resistive touch panels which are cost effective but fail to deliver multi-touch.

In contrast to traditional resistive touch panels effective in single-touch, capacitive touch panels installed on mobile phones or tablet personal computers of Apple Inc. first support multi-touch and provide graphic operation interfaces rich in diversified operation models and funs, earning consumers' universal acceptance and preference, and causing capacitive touch panels to be installed on more and more 3C products.

A capacitive touch panel which is directly operated by fingers is less convenient than a touch pen during touch input, and some users still prefer operating a capacitive touch panel by a pen-like tool. In this regard, a touch pen traditionally used in a resistive touch panel cannot be directly applicable to a capacitive touch panel whose induction is different from that of a resistive touch panel.

With specific shapes and structures, lots of capacitive touch pens exclusively developed for those capacitive touch panels and available in the market belong to independent and function-completed capacitive touch control devices that are not integrated into a user's multiple paraphernalia to which a capacitive touch pen must be added particularly. As a result, a user has to carefully find an easily carried capacitive touch pen in order to reduce personal load.

### SUMMARY OF THE INVENTION

The present invention provides a portable touch control accessory which can be adequately installed on columnar paraphernalia for the paraphernalia used in operating a capacitive touch panel in view of some users' preference for operating a capacitive touch panel by a pen-like tool and a traditional capacitive touch pen not integrated with a user's multiple paraphernalia.

The present invention of a portable touch control accessory in one embodiment comprises:

A connecting part, a nonconducting tubular element with a bore at one end which can be adequately coupled with columnar paraphernalia;

A touch control component which is conductive and mounted at the connecting part's other end via a connecting device; and

A conductive part, conductive and flexible, which is electrically connected to the touch control component and has at least one portion exposed to contact a human body for development of a ground loop.

The portable touch control accessory can be taken as one accessory installed on one user's multiple paraphernalia which is used in operating a capacitive touch panel when a ground loop is developed with the touch control component contacting a human body via the conductive part.

For the structure of the present invention in one embodiment, the connecting part is one flexible elastic component which is manufactured with one nonconducting material among rubber, silica gel or plastic.

For the structure of the present invention in one embodiment, the touch control component is one pliable conductive component which is manufactured with one conductive material among conductive rubber, conductive plastic, conductive fabric or conductive foam or with a combination of these materials thereof.

For the structure of the present invention in one embodiment, the conductive part is one flexible conductive component which is manufactured with one conductive material among copper, aluminum, conductive yarn, conductive filament, conductive fabric or other metals.

For the structure of the present invention in one embodiment, the conductive part can be installed on exterior or interior of the connecting part or be coated inside the connecting part with at least one portion exposed.

For the structure of the present invention in one embodiment, the connecting device can be either a threaded structure or a mosaic structure for the touch control component mounted at one end of the connecting part and freely replaced with another touch control component.

For the structure of the present invention in one embodiment, both the touch control component and the conductive part with ornamental shapes can be taken as one user's adornments.

It can be seen from above descriptions for the present invention that the present invention of a portable touch control accessory is installed on one user's columnar paraphernalia (e.g., ball-point pen) by means of a connecting part for an electric loop developed by a touch control component which contacts a human body via a conductive part. On the other and, the present invention of a portable touch control accessory can be taken as a portable adornment for more value added by both the touch control component and the conductive part with ornamental shapes.

Additionally, the conductive part as one adornment can be developed to be multiple shapes such as animal, plant, cartoon character or geometric icon.

The present invention's other functions and embodiments are further illustrated with drawings as follows.

### DETAILED DESCRIPTIONS OF THE PREFERRED EMBODIMENTS

As shown in FIG. 1 for illustration of the structure of the first embodiment, the present invention of a portable touch control accessory comprises:

A connecting part 10 which is a nonconducting tubular component with a bore 11 at one end wherein the bore 11 with its cross-section developed to be a circle, a polygon or any irregular shape is adequately coupled with either columnar paraphernalia or one end of a ball-point pen 40 at one example as shown in FIG. 4;

A touch control component 20 which is conductive and mounted at the other end (opposite to the other end of the bore 11) of the connecting part 10 via a connecting device; and

A conductive part 30, conductive and flexible, is electrically connected to the touch control component 20 and has at least an exposed contact segment 31 which contact a human body for development of an electric loop.

The connecting part 10 is an flexible elastic component, which has the bore 11 steadily coupled with columnar paraphernalia or paraphernalia's columnar part, for example, the bore 11 coupled with and not loosened from a ball-point pen, an eyebrow pencil or paraphernalia's columnar part, and is manufactured with one nonconducting material among rubber, silica gel or plastic.

The touch control component 20 which is a pliable conductive component and used by one user to directly contact a capacitive touch panel is manufactured with one flexible material not damaging a capacitive touch panel such as conductive rubber, conductive plastic, conductive fabric or conductive foam or a combination of these materials thereof; the exterior shape of a touch control component 20 with a conductive material such as conductive rubber, conductive plastic or conductive foam can be developed to be an adornment directly, for instance, cartoon character or other ornamental shapes (as shown in FIG. 7) and make the present invention become a user's portable ornament.

Referring to FIG. 5 which illustrates the structure of another embodiment for the touch control component 20 manufactured with an adequately pliable material among rubber, silica gel, plastic or foam, developed to be a predetermined shape, and coated with one layer of conductive fabric 21 externally.

The connecting device can be a threaded structure as shown in FIG. 2 or a mosaic structure as shown in FIG. 3 for the touch control component 20 installed at one end of the connecting part 10 or freely replaced by another touch control component 20. For the embodiment as shown in FIG. 2, there is a thread 22 designed at one end of the touch control component 20 and a corresponding thread 12 at one end of the connecting part 10 that a user can use both the thread 22 and the thread 12 to mount the touch control component 20 at one end of the connecting part 10 or remove the touch control component 20 from the connecting part 10 and replace it by another touch control component 20 with a different shape.

For the mosaic structure of the embodiment as shown in FIG. 3, there is a rib 13 located at one end of the connecting part 10 and protruding toward its center and there is a concave groove 23 designed in outer margins at one end of the touch control component 20. As one pliable conductive component, the touch control component 20 allows its groove 23 to be easily embedded into the rib 13 of the connecting part 10 for the touch control component 20 mounted at one end of the connecting part 10 or removed from the connecting part 10 and replaced by another touch control component 20 with a different shape.

Despite these two embodiments for the connecting device of the present invention disclosed herein, any person skilled in the art should be able to deliver the said connecting device by slight change or other equivalent structures after being familiar with the technical characteristics and specifications of the present invention, for example, a simple change that one end of the touch control component 20 is designed to be a tubular structure and coupled with one end of the connecting part 10 is not departing from the technical domain of the present invention.

The conductive part 30 is a flexible or rigid conductive material and manufactured with one conductive material among copper, aluminum, conductive yarn, conductive filament, conductive fabric or other metals. FIG. 1 illustrates an embodiment of the conductive part 30 manufactured with conductive yarn or conductive filament wherein the long linear conductive part 30 is wrapped around paraphernalia or a user's finger.

FIG. 6 illustrates another embodiment in which the long linear conductive part 30 is annular can be taken as a general phone strap or a suitable article or ornament with aesthetical value hanged on the body. FIG. 7 illustrates another embodiment in which both the conductive part 30 developed by several conductive yarns or conductive filaments and the doll-like touch control component 20 become a doll with hairs or a portable ornament. FIG. 8 illustrates another embodiment in which there is the flaky connecting part 30 manufactured with conductive fabrics.

The conductive part 30 can be installed outside the connecting part 10 (FIG. 2) or inside the connecting part 10 (FIG. 3) or coated inside the connecting part (FIG. 9). Wherever the connecting part 10 is provided with the conductive part 30, the conductive part 30 has at least one conductive end 32 contacting the touch control component 20 wherein the conductive part 30 is adhered to the exterior surface of the connecting part 10 and the conductive end 32 is installed at a junction of the touch control component 20 and the connecting part 10, as shown in FIG. 2 for one embodiment: the conductive end 32 is clipped between the touch control component 20 and the connecting part 10 for the conductive end 32 of the conductive part 30 electrically connected to the touch control component 20 when the touch control component 20 links the connecting part 10 via a threaded structure or a mosaic structure.

As shown in FIG. 3, an embodiment for the conductive part 30 installed at an interior side of the connecting part 10 illustrates the connecting part 10 is provided with a groove at its interior side for the conductive part adhered into the groove; when paraphernalia is held by one user, an electrical loop will be developed with the touch control component 20 contacting the human body via a contact segment 31 of the conductive part 30 for the paraphernalia used in operation of a capacitive touch panel.

Additionally, the conductive part 30 as one ornament can be manufactured to be any shape such as animal, plant, cartoon character or geometric shape.

Furthermore, both the touch control component 20 and the connecting part 10 can be manufactured to be a one-piece structure.

Amongst the said embodiments, the contact segment 31 on the conductive part 30 longer than one terminal of the bore 11 on the connecting part 10 is a preferred embodiment of the present invention only and not used to restrict claims; the length of the contact segment 31 on the conductive part 30 can be shorter than or equal to but does not exceed one terminal of the bore 11 on the connecting part 10.

Notwithstanding the foregoing disclosures for the present invention, the embodiments are not used in restricting the present invention and any person skilled in the arts could make some changes without departing from spirit and scope of the present invention. Accordingly, the scope of patent protection for the present invention will depend on claims in the patent specifications.

### BRIEF DESCRIPTIONS OF THE DRAWINGS

FIG. 1 illustrates the structure of a portable touch control accessory in one embodiment of the present invention.

FIG. 2 illustrates the cross-sectional view of a connecting part and a touch control component in one embodiment of a connecting device.

FIG. 3 illustrates the cross-sectional view of a connecting part and a touch control component in another embodiment of a connecting device.

FIG. 4 illustrates the schematic diagram of using the present invention for a connecting part of the portable touch control accessory coupled with a ball-point pen.

FIG. 5 illustrates the cross-sectional view of a touch control component in another embodiment of the touch control component.

FIG. 6 illustrates an annular conductive part of a portable touch control accessory in another embodiment of the present invention.

FIG. 7 illustrates the ornamental shape of a touch control component in another embodiment of the present invention.

FIG. 8 illustrates the flaky conductive part of a portable touch control accessory in another embodiment of the present invention.

FIG. 9 illustrates the cross section of a conductive part coated on a connecting part in another embodiment of the present invention.

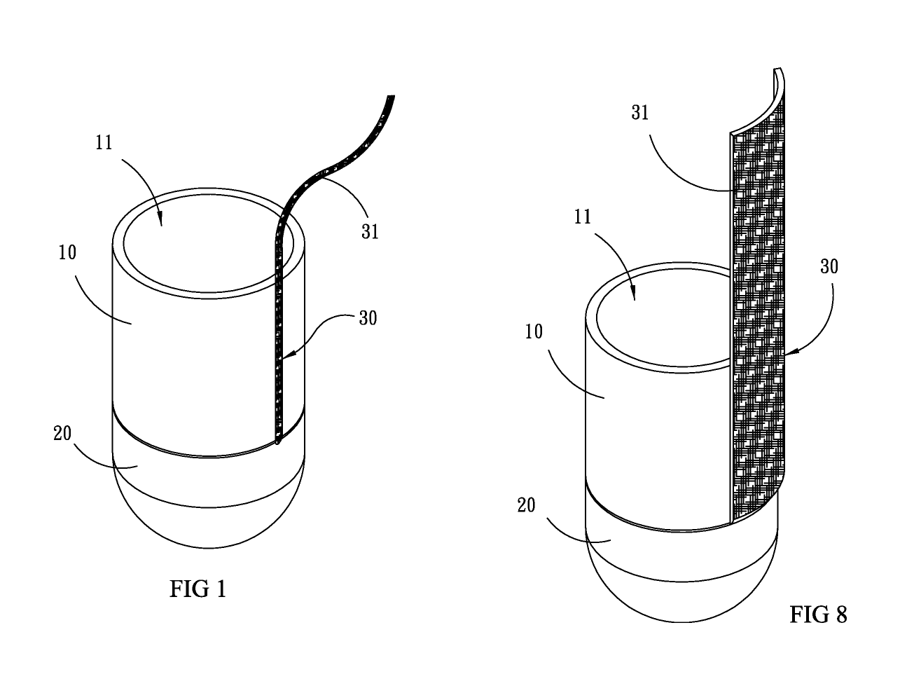

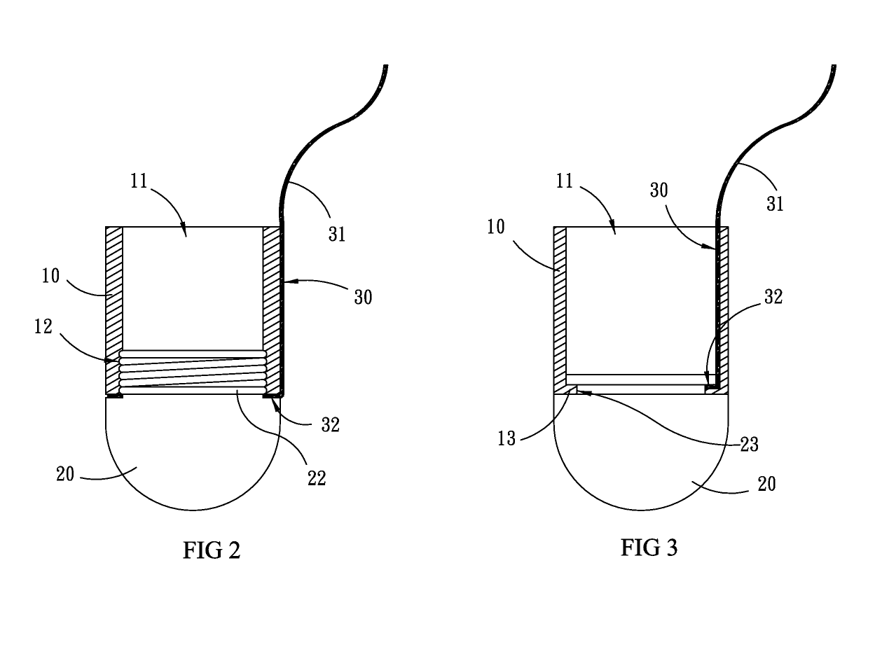

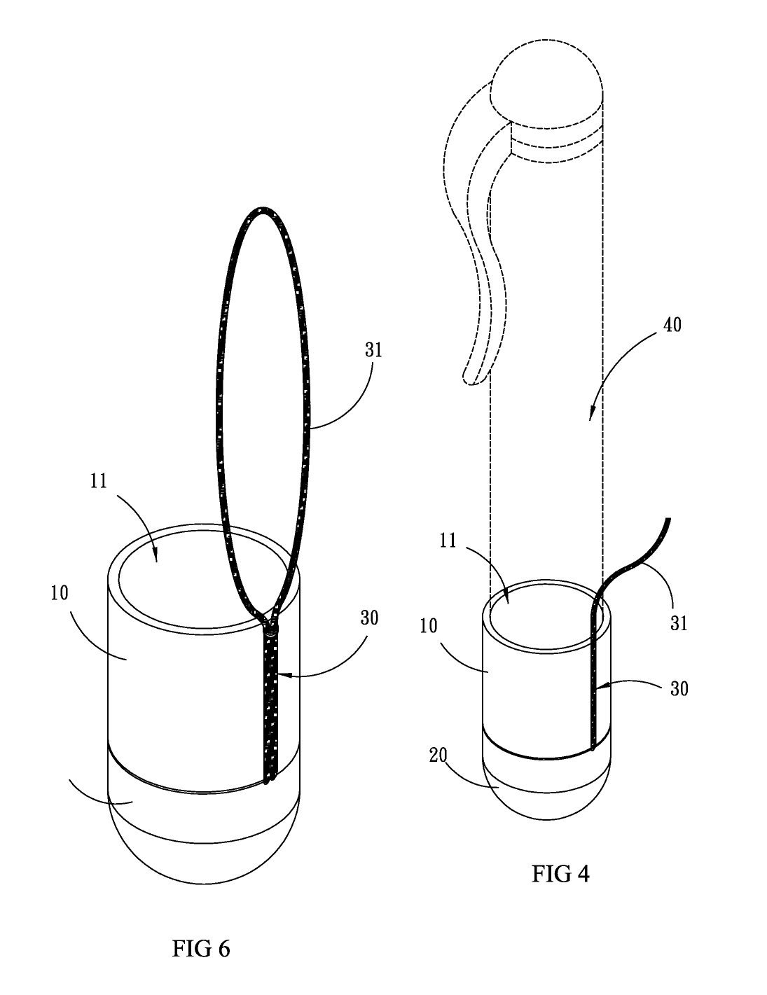

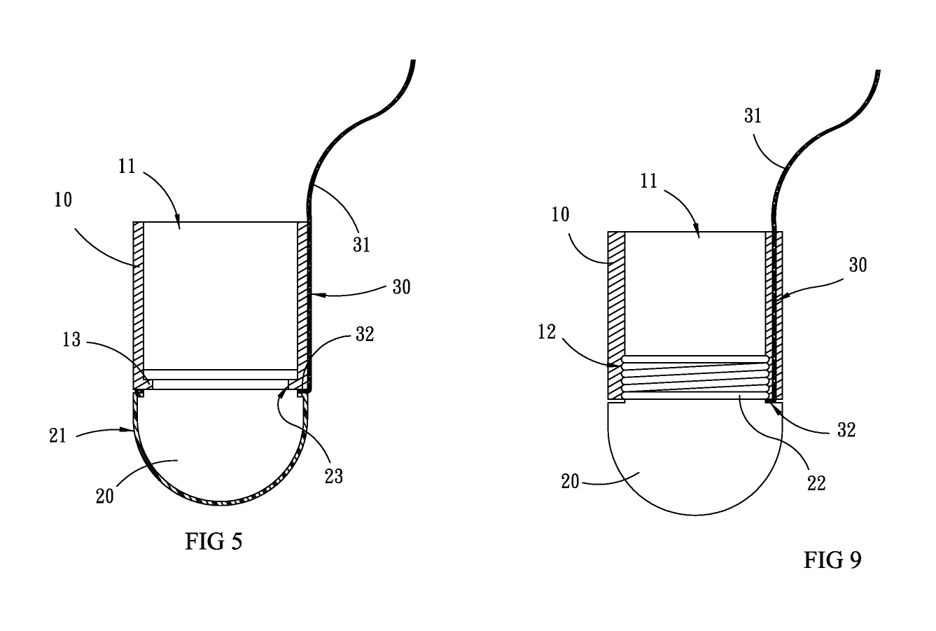

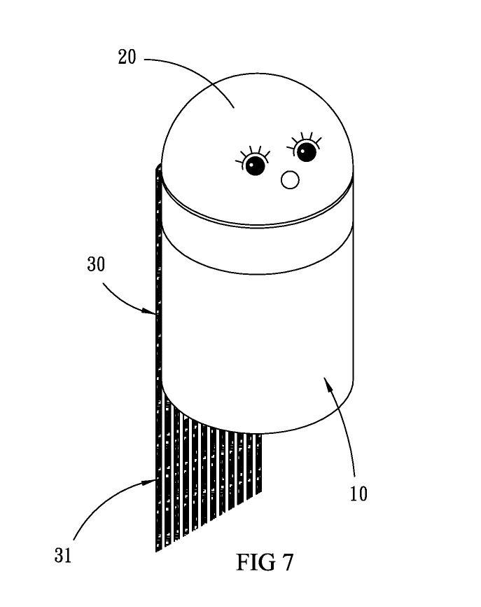

What is claimed is:

1. A portable touch control accessory, which is adequately installed on columnar paraphernalia for the paraphernalia used in operating a capacitive touch panel, comprising:
A connecting part which is a nonconducting tubular component with a bore at one end wherein the bore is adequately coupled with columnar paraphernalia;
A touch control component which is conductive and mounted at the other end of the connecting part via a connecting device; and
A conductive part which is electrically connected to the touch control component and has at least a contact segment used to contact the human body for development of an electric loop.

2. The portable touch control accessory according to claim 1 wherein the connecting part can be manufactured with one nonconducting material among rubber, silica gel or plastic.

3. The portable touch control accessory according to claim 1 wherein the touch control component is one conductive element which can be manufactured with one conductive material among conductive rubber, conductive plastic, conductive fabric or conductive foam or a combination of these materials thereof.

4. The portable touch control accessory according to claim 1 wherein the connecting part is one flexible elastic connecting part.

5. The portable touch control accessory according to claim 1 wherein the conductive part can be optionally manufactured with one conductive material among copper, aluminum, conductive yarn, conductive filament, conductive fabric or other metals.

6. The portable touch control accessory according to claim 1 wherein the conductive part can be installed at exterior or interior of the connecting part or coated inside the connecting part.

7. The portable touch control accessory according to claim 1 wherein the conductive part is one annular conductive part.

8. The portable touch control accessory according to claim 1 wherein the connecting device can be a threaded structure or a mosaic structure for the touch control component installed at one end of the connecting part via the connecting device.

9. The portable touch control accessory according to claim 8 wherein the threaded structure comprises a thread at one end of the touch control component and a corresponding thread at one end of the connecting part for the touch control component installed at the connecting part's one end or the touch control component removed from the connecting part.

10. The portable touch control accessory according to claim 8 wherein the mosaic structure comprises a rib, which is located at one end of the connecting part and protrudes toward its center, and a groove in outer margins at the touch control component's one end for the groove of the touch control component embedded into the rib of the connecting part and the touch control component mounted at one end of the connecting part or removed from the connecting part.
